(19) United States
(12) Patent Application Publication
(10) Pub. No.: US 2015/0312495 A1
(43) Pub. Date: Oct. 29, 2015

(54) Wavelet denoising of fringe image

(71) Applicant: CANON KABUSHIKI KAISHA, Tokyo (JP)

(72) Inventors: RUIMIN PAN, Macquarie Park (AU); Donald James Bone, Wentworth Falls (AU)

(21) Appl. No.: 14/697,396

(22) Filed: Apr. 27, 2015

(30) Foreign Application Priority Data
Apr. 29, 2014 (AU) 2014202322

(51) Int. Cl. H04N 5/357; G06K 9/52; G06T 3/00; G06T 5/00

(52) U.S. Cl. CPC H04N 5/357; G06T 5/00; G06K 9/52; G06T 3/00; G06T 2207/10116

(57) ABSTRACT

Disclosed is an image de-noising processing method which is particularly suited to X-ray Talbot images. The method captures a fringe pattern from an energy source, the captured fringe pattern having a carrier frequency component dependent on settings of the energy source. Wavelet coefficients are obtained for the captured fringe pattern by applying a wavelet transform to the captured fringe pattern. The method establishes a wavelet coefficients mapping function having a rate of change that varies depending at least on the carrier frequency component of the captured fringe pattern, and transforms the obtained wavelet coefficients using the established wavelet coefficients mapping function. The captured fringe pattern is then processed by applying inverse wavelet transform to the transformed wavelet coefficients to form a denoised fringe pattern.

### REFERENCE TO RELATED PATENT APPLICATION(S)

This application claims the benefit under 35 U.S.C. §119 of the filing date of Australian Patent Application No. 2014202322, filed Apr. 29, 2014, hereby incorporated by reference in its entirety as if fully set forth herein.

### TECHNICAL FIELD

The current invention relates to the suppression of noise in a captured fringe image produced with an energy source, such as in an interferometer.

### BACKGROUND

Image capture devices project a scene, natural or artificial, onto a two-dimensional surface. This two-dimensional projection provides an easy approach to transmitting and analysing information about the original scene. Meanwhile, the image capture process always involves blurring, noise and many other different kinds of degradation.

In the case of noise, it is very important to understand the nature of the noise, so as to be able to remove or suppress the noise efficiently. For example, additive noise can be effectively removed by many linear, non-linear filtering, or smoothing techniques, such as bilateral filtering or non-local means method. For noise such as Poisson noise (shot noise), one of the most effective denoising approaches is to physically obtain more captures of the same scene and to average across all the captures. This is due to the nature of Poisson noise, where the signal to noise ratio increases with the number of photons.

As a tool for analysing and compressing images, wavelet theory is widely used for image enhancement. Due to its flexibility between high spatial resolution and high frequency resolution, wavelet theory has been utilized in a ‘wavelet shrinkage’ algorithm for denoising. Wavelet shrinkage does not assume a smooth and continuous signal, which makes wavelet shrinkage viable for signals with discontinuities. Furthermore, because the wavelet transform maps white noise in the signal domain to white noise in the transform domain, wavelet transformation spreads the noise energy out while keeping the signal energy in a few wavelet coefficients, and thus separates noise and signal well. In other words, a simple thresholding in the wavelet domain can remove or suppress the noise and maintain the signal.

A standard wavelet shrinkage process involves three steps:
1. Digital wavelet transformation of the noisy image;
2. Thresholding the wavelet coefficients using a thresholding function;
3. Inverse wavelet transformation of the thresholded/denoised coefficients.

Among the three steps of wavelet shrinkage, the second step, thresholding the wavelet coefficients, is the most important. Currently there are two popular thresholding functions in the art: hard threshold and soft threshold. FIG. 17A illustrates the hard threshold rule and FIG. 17B illustrates the soft threshold rule. In FIGS. 17A and 17B, the axis labelled with ‘y’ represents the wavelet coefficients of the original noisy image, the axis labelled with ‘co’ represents the wavelet coefficients of the denoised image. In FIG. 17A (depicting hard threshold), wavelet coefficients whose values fall in the range [−T, T] are set to zero while other coefficients remain the same, thereby displaying a linear inter-relationship. In FIG. 17B (depicting soft threshold), wavelet coefficients whose values fall in the range [−T, T] are set to zero while other coefficients are shrunk by T, nevertheless again displaying a linear inter-relationship beyond the range [−T,T]. The region [−T, T] is normally referred to as the ‘dead zone’, and the threshold value T is referred to as ‘dead zone size’ in this specification, whilst the value T traditionally has been determined by estimated noise strength of the original noisy image.

Both the hard and the soft shrinkages have advantages and disadvantages. The soft shrinkage estimates tend to have a bigger bias due to the fact that all coefficients are either set to zero or shrunk by T, while the hard shrinkage estimates tend to have bigger variance and are sensitive to small changes in the data.

Since the introduction of wavelet shrinkage algorithm, many improvements have been suggested by various researchers. Most improvements are focused on subband-specific thresholding, exploring inter-scale dependency or a better estimation of the noise strength. That is, the parameters of the wavelet thresholding function are chosen based on an estimate of the noise strength, and the parameters vary from sub-band to sub-band. However, it is always possible that some wavelet coefficients outside the dead zone are actually noise and some wavelet coefficients inside the dead zone are in fact useful signal. For example, at a particular subband, frequency components from the original noisy image that match the resolution of this subband will be represented with a few strong coefficients while higher frequency components are represented with small coefficients. When thresholding in this subband, small coefficients representing useful signals with these higher frequency components will be treated as noise and set to zero. This will result in an uneven representation of the useful signal in the denoised image, even when the dead zone size T is carefully chosen to reflect the noise strength in the original image.

For images such as portrait photos and photos of nature, this uneven representation tends to have limited impact as these images tend to have a relatively flat spectral representation. That is, they have a wide range of frequency components with similar energy in each frequency component. It is, however, a much more prominent problem for fringe images captured in an interferometer. In such a fringe image, accidentally attenuating the frequency components that represent the carrier fringe will lead to disastrous denoised results, which will cause large error in later demodulation step.

There is a need for an algorithm that is able to remove noise in a fringe image without causing substantial errors in further image processing.

### SUMMARY

According to one aspect of the present disclosure there is provided an image processing, for example de-noising, method, the method comprising:

capturing a fringe pattern from an energy source, the captured fringe pattern having a carrier frequency component dependent on settings of the energy source;

obtaining wavelet coefficients for the captured fringe pattern by applying a wavelet transform to the captured fringe pattern;

establishing a wavelet coefficients mapping function having a rate of change that varies depending at least on the carrier frequency component of the captured fringe pattern;

transforming the obtained wavelet coefficients using the established wavelet coefficients mapping function; and

processing the captured fringe pattern by applying inverse wavelet transform to the transformed wavelet coefficients to form a denoised fringe pattern.

Preferably the method further comprises demodulating he captured fringe pattern to determine at least the carrier frequency component ( ) and a modulation strength to which the fringe pattern is modulated by an object being imaged using the energy source. Typically the established wavelet coefficients mapping function is further based on the determined modulation strength. The method may further comprise demodulating the denoised fringe pattern using the determined carrier frequency.

In a specific implementation, the method establishes the wavelet coefficients mapping function further comprises determining a range of magnitude values of the wavelet coefficients, where the wavelet coefficients with magnitude within said range are set to zero, the range is determined based on estimated noise variance in the captured fringe pattern.

Desirably the rate of change of the established wavelet coefficients mapping function is non-linearly dependent on the carrier frequency component. Preferably the rate of change of the established wavelet coefficients mapping function determines a suppressing rate for the wavelet coefficients with a magnitude outside the predetermined range.

In another implementation, the transforming the obtained wavelet coefficients further comprising:

setting the magnitude of wavelet coefficients with magnitude within a predetermined range to zero; and

suppressing the magnitude of at least one wavelet coefficient with magnitude outside the predetermined range in accordance with the suppressing rate determined based on the carrier frequency component, the suppressing rate being established by the wavelet coefficients mapping function.

Further, the wavelet coefficients mapping function may be further determined using strength to which the fringe pattern is modulated by an object being imaged using the energy source.

According to another aspect of the present disclosure provides an image processing method, the method comprising:

capturing a fringe pattern from an energy source, the captured fringe pattern having a carrier frequency component dependent on settings of the energy source;

obtaining wavelet coefficients for the captured fringe pattern by applying a wavelet transform to the captured fringe pattern;

establishing a wavelet coefficients mapping function that varies depending on the carrier frequency component of the captured fringe pattern;

transforming the obtained wavelet coefficients using the established wavelet coefficients mapping function; and

processing the captured fringe pattern by applying inverse wavelet transform to the transformed wavelet coefficients to form a denoised fringe pattern.

In another aspect, disclosed is an image processing method, the method comprising:

capturing a fringe pattern from an energy source, the captured fringe pattern having a carrier frequency component dependent on settings of the energy source;

obtaining wavelet coefficients for the captured fringe pattern by applying a wavelet transform to the captured fringe pattern;

suppressing the obtained wavelet coefficients in accordance with the carrier frequency component of the captured fringe pattern, wherein the suppressing rate increases with increasing the carrier frequency of the captured fringe pattern; and

processing the captured fringe pattern by applying inverse wavelet transform to the suppressed wavelet coefficients to form denoised fringe pattern.

In these methods, the wavelets coefficient mapping function desirably comprises a thresholding function expressed by:

$$ω = \{ \begin{matrix}\frac{T * y - sgn ( y ) F + sgn ( y ) \sqrt{{[ sgn ( y ) F + T * y ]}^{2} - 4 {T}^{2} F}}{2 T} & \vert y \vert \geq T > 0 \\ 0 , & otherwise\end{matrix} \qquad ( a )$$

where T is the dead zone size and F is a curvature parameter that changes the shape of the function.

Most preferably, the thresholding function is interpreted using the expression:

$$y = \{ \begin{matrix}ω + \frac{T * F}{ω * T + sgn ( ω ) * F} & \vert w \vert > 0 \\ \pm T , & otherwise\end{matrix} \qquad ( b )$$

where ‘*’ indicates multiplication, and that solving Equation (b) for ω will result in Equation (a), Equation (b) defines a mapping from noisy wavelet coefficients y to denoised wavelet coefficients ω, such that in Equations (a) and (b), sgn(x)=1 where x>0, and sgn(x)=−1 where x<0.

Other aspects are also disclosed.

### BRIEF DESCRIPTION OF THE DRAWINGS

At least one embodiment of the invention will now be described with reference to the following drawings, in which:

FIG. 1 is a diagram of the experimental set-up for an X-ray Talbot interferometer;

FIG. 2 is a schematic flow diagram describing the traditional demodulation process of a fringe image;

FIG. 3 is a schematic flow diagram of the demodulation process of a fringe image with an extra denoising step;

FIG. 4 is a schematic block diagram of the denoising process using the wavelet shrinkage framework with a new thresholding function;

FIG. 5 is a block diagram of the calculation of the curvature parameter that determines the shape of the new thresholding function;

FIG. 6 is a flow diagram demonstrating the peak finding process in order to determine the fringe frequency of a fringe image.

FIG. 7 is a flow diagram illustrating the wavelet shrinkage framework;

FIG. 8 is a flow diagram explaining the process of combining look-up tables from different training images;

FIG. 9 illustrates the look-up table generation process for each individual training image;

FIG. 10 is a flow diagram explaining the search for the curvature parameter given fringe frequency and modulation strength values;

FIG. 11 briefly lays out the image simulation process for look-up table generation;

FIG. 12A illustrates a fringe image with object information;

FIG. 12B illustrates a demodulated fringe image with object information only;

FIG. 13A illustrates a fringe image with one-dimensional fringes;

FIG. 13B shows the profile of the fringes in FIG. 13A;

FIG. 14A illustrates a fringe image with two-dimensional fringes;

FIG. 14B shows the profile of the fringes in FIG. 14A;

FIGS. 15A and 15B illustrate examples of the gratings described in FIG. 1;

FIG. 16 illustrates examples of the new thresholding function;

FIG. 17A illustrates the original soft-threshold function (prior art);

FIG. 17B illustrates the original hard-threshold function (prior art);

FIG. 18 illustrates the frequency domain representation of a fringe image; and

FIGS. 19A and 19B form a schematic block diagram of a general purpose computer system upon which arrangements described can be practiced.

### DETAILED DESCRIPTION INCLUDING BEST MODE

### Context

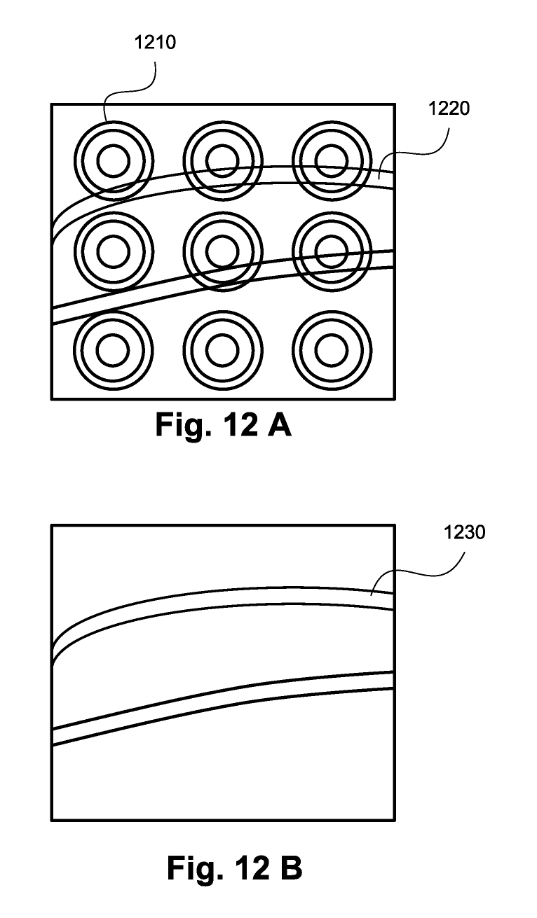

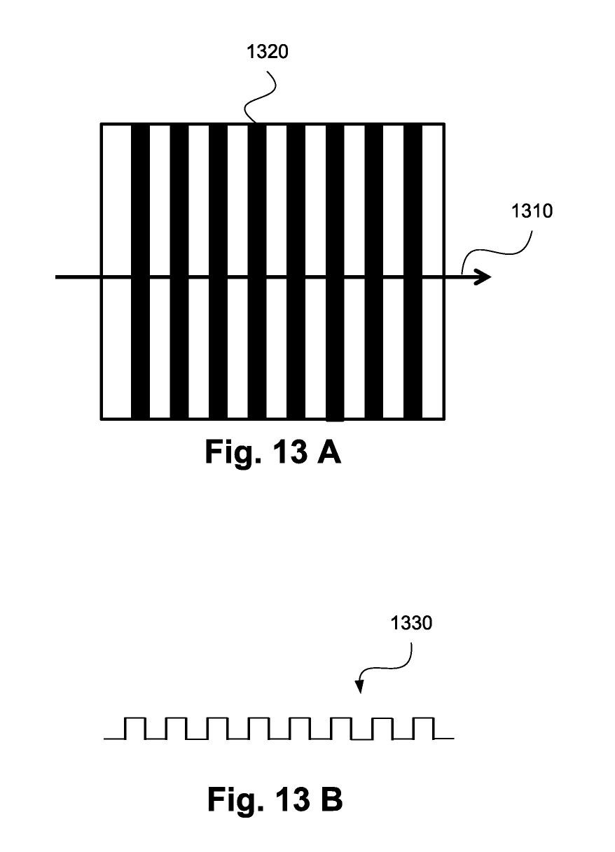

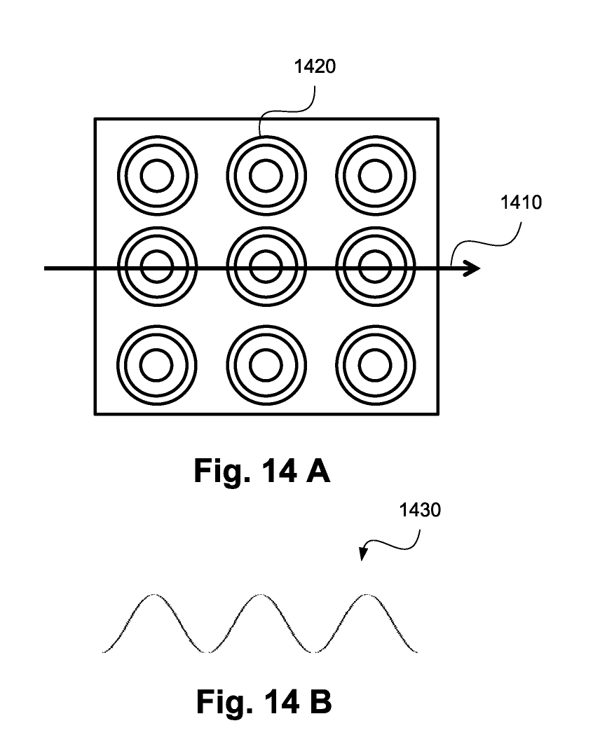

A ‘fringe image’ refers to an image with at least one dominant one-dimensional or two-dimensional periodical signal. FIG. 13A demonstrates an example of a one-dimensional fringe image 1320 and FIG. 13B shows a profile 1330 of the fringe image 1320 along an indicated direction 1310. Similarly, FIG. 14A shows an example of a two-dimensional periodical signal 1420, while FIG. 14B shows the profile 1430 of FIG. 14A along the indicated direction 1410. In most image capture systems, the fringe image includes not only the fringe (periodical signal), but also some extra object information that is modulating the periodical signal and this object information is in fact the target of the image capture. The fringe itself often acts as a carrier frequency that helps the formation of an image in order to transmit this extra object information. The carrier frequency component of the fringe pattern is dependent on settings of the energy source from which the fringe is produced. FIG. 12A illustrates a fringe image 1210 with object information 1220, and FIG. 12B shows the object information 1230 after removal of the fringes. In FIG. 12A, the fringe 1210 is the same two-dimensional fringe as shown in FIG. 14.

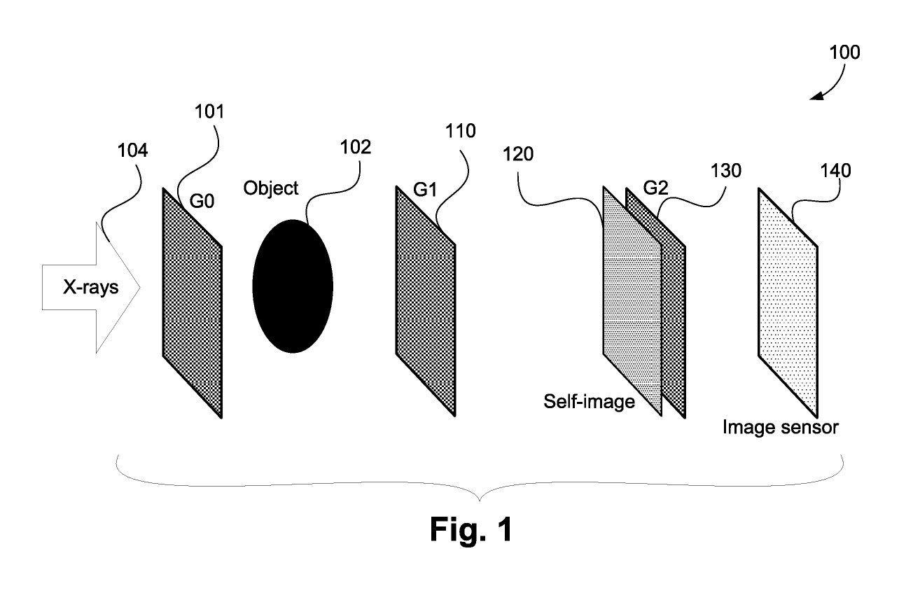

Many imaging systems can produce fringe images such as the one in FIG. 12A. One example is a two-dimensional X-ray Talbot (XT) image system. FIG. 1 shows an example of an X-ray Talbot interferometer arrangement 100, in which a source grating G0 101, an object 102, and a phase grating G1 110 are illuminated by an X-ray energy source 104. A self-image 120 is formed behind the phase grating G1 110 due to the Talbot effect. Since the phase of the X-ray wave is shifted by the object 102, the self-image 120 is deformed. By analysing the deformed self-image 120, the characteristics of the object 102 can be deduced. Because this type of X-ray imaging uses phase differences instead of absorption to produce contrast, the resolution of an XT system is much higher than conventional absorption X-ray. In FIG. 1, a second absorption grating G2 130, configured at the position of the self-image 120 helps generate a moiré fringe pattern. Normally the period of the second absorption grating G2 130) is designed to be similar to that of the self-image 120, so the moiré pattern generated by superposing the deformed self-image 120 and G2 130 gives a much larger version of the original self-image in order for an image sensor 140 to capture or resolve the fringe pattern from the image of the object 102, being an XT image. The carrier frequency of the fringe pattern will be dependent on the pitch of the gratings and the distance between the object and G1 as well as the distance between G1 and G2. “Pitch” means the regular distance between two adjacent holes in the grating, such as in 1520.

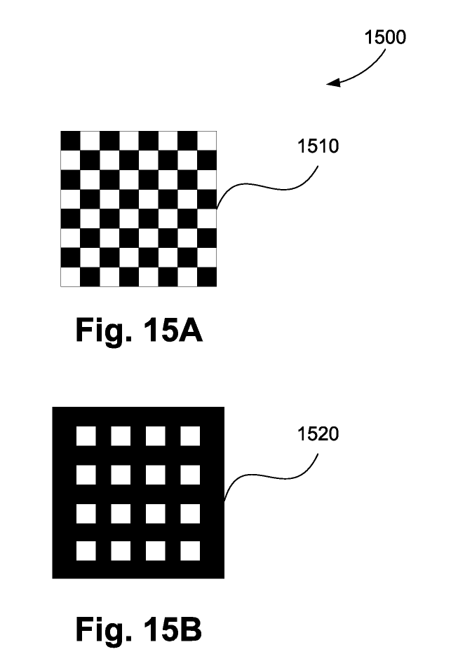

The gratings in FIG. 1 can be either one-dimensional (1D) or two-dimensional (2D) gratings. Examples of 2D gratings are shown in FIGS. 15A and 15B, where a grating 1510 illustrates an example of the phase grating G1 110, and a grating 1520 illustrates an example of the absorption grating G2 130. In the phase grating 1510, the dark areas represent regions on G1 110 where a phase shift of π is imposed, and the bright areas represent regions on G1 110 where no phase shift is imposed. In the absorption grating 1520, the dark areas represent regions on G2 130 that absorb most of the X-ray energy, the bright areas represent regions on G2 130 that let the X-ray energy go through.

XT images are inherently noisy due to the photon process (Poisson noise) and thermal noise, readout noise, background noise. These three noise sources can all be modelled with additive Gaussian noise.

The fringe pattern generated in the XT imaging system 100 and detected by the image sensor 140 can be approximately expressed as:

z(r)=¼a(r)(1+mₓ(r)cos(φₓ)(r))(1+m_{y})(r)cos(φ_{y}(r))) (1)

where z(r) is the intensity value at position r in the captured XT image;
mₓ(r) and m_{y}(r) are the x and y modulation strengths of the cosine components;
φₓ(r) and φ_{y}(r) are phase functions related to the phases ξₓ(r), ξ_{y}(r) of the object 102 in the x and y directions; and
a(r) is the absorption factor.

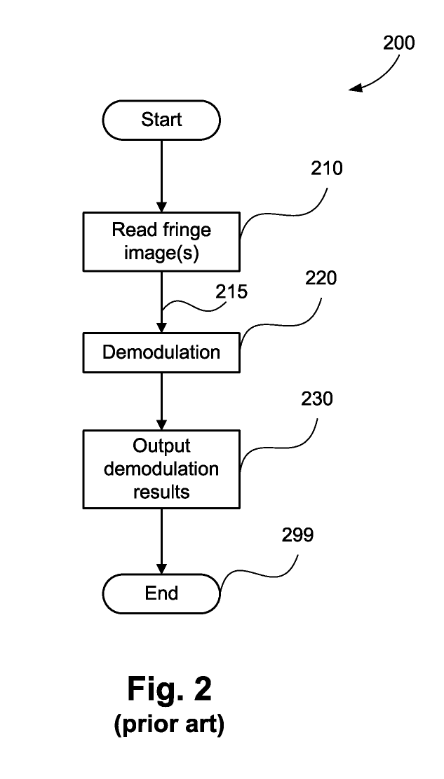

Fringe images z(r) captured in the XT system 100 need to be demodulated to recover the x and y phases ξₓ(r) and ξ_{y}(r) of the object 102. A demodulation process 200 is explained with reference to the flowchart of FIG. 2. In FIG. 2, step 210 reads at least one fringe image 215 captured by the sensor 140, step 220 performs the demodulation to remove the carrier fringe frequency, and step 230 outputs the demodulated results. There are many different demodulation algorithms to recover information about the object 102. For example, a phase stepping method recovers the x and y modulation strength mₓ, m_{y}, the phase functions φₓ, φ_{y}, and the absorption factor a, by capturing more than one image z(r) and solving a set of linear equations. The output of the demodulation in step 230 normally includes five images: a(r), mₓ(r), m_{y}(r), ξₓ(r) and ξ_{y}(r), with ξₓ(r) and ξ_{y}(r) being derived from φₓ(r) and φ_{y}(r) in Equation (1), respectively. The relationship between the phase functions and the object phase can be expressed as shown in Equation (2):

φₓ(r)=2 πxfₓ+ξₓ(r) and φ_{y}(r)=2 πyf_{y}+ξ_{y}(r) (2)

where fₓ and f_{y} are the horizontal and vertical fringe frequency components. The object phase ξₓ and ξ_{y} are the x and y derivatives of the optical path length of the object

$$ψ ( r ) \text{:} ξ = \frac{\partial ψ}{\partial x} ( r ) , {ξ}_{y} = \frac{\partial ψ}{\partial y} ( r ) .$$

The values of mₓ(r) and m_{y}(r) fall between 0 and 1 and the values of ξₓ(r) and ξ_{y}(r) are between 0 and 2 π.

As illustrated in FIGS. 13A to 14B, the carrier fringe in the captured image can be a one-dimensional or two-dimensional fringe. For two-dimensional fringes, the fringe frequency value f can be expressed generally with a horizontal component fₓ and a vertical component f_{y}.

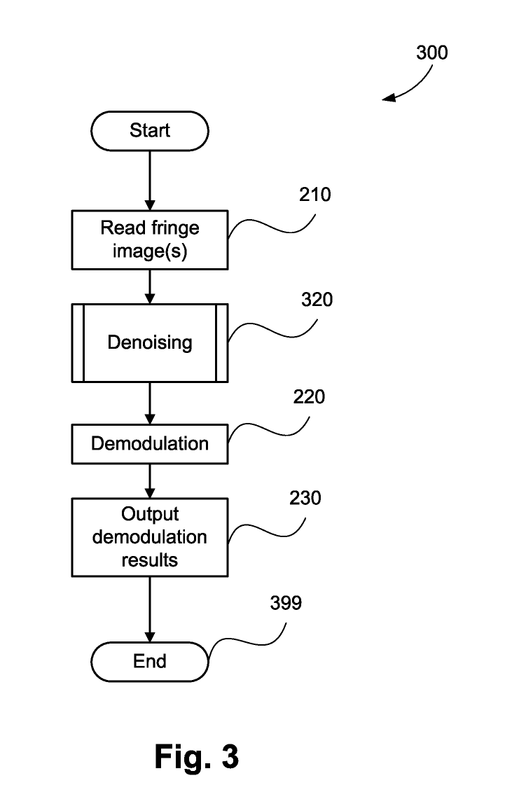

In order to achieve a better image quality for the demodulated images, a ‘denoising’ step can be performed before the demodulation step 220. The new processing flow is shown in a method 300 in FIG. 3, where an extra denoising step 320 is added before the demodulation step 220.

However, one potential problem with performing denoising before demodulation, as shown in FIG. 3, is that denoising tends to smooth high frequencies, thereby risking distortion in the fringe signal and potentially causing problems for later demodulation, where accurate estimation of the fringe frequency is necessary for proper demodulation. Therefore, it is highly desired to be able to change the amount of smoothing according to the fringe frequency and signal modulation strength. Meanwhile, a good estimate of noise strength is also important for adapting the degree of denoising. In summary, a good noise removal or suppression algorithm for fringe images should be tuned depending on noise strength, modulation strength and fringe frequency.

In this specification, the term ‘fringe image’ refers to captured images in an imaging system such as an interferometer that has at least one periodical signal and may or may not have the object information. In other words, the examples shown in FIG. 12A and FIG. 14A can be both referred to as ‘fringe image’. On the other hand, the term ‘fringe’ alone will be used to describe the periodical signal only, such as the signals 1320 and 1420 shown in FIGS. 13A and 14A respectively.

### Physical Implementation

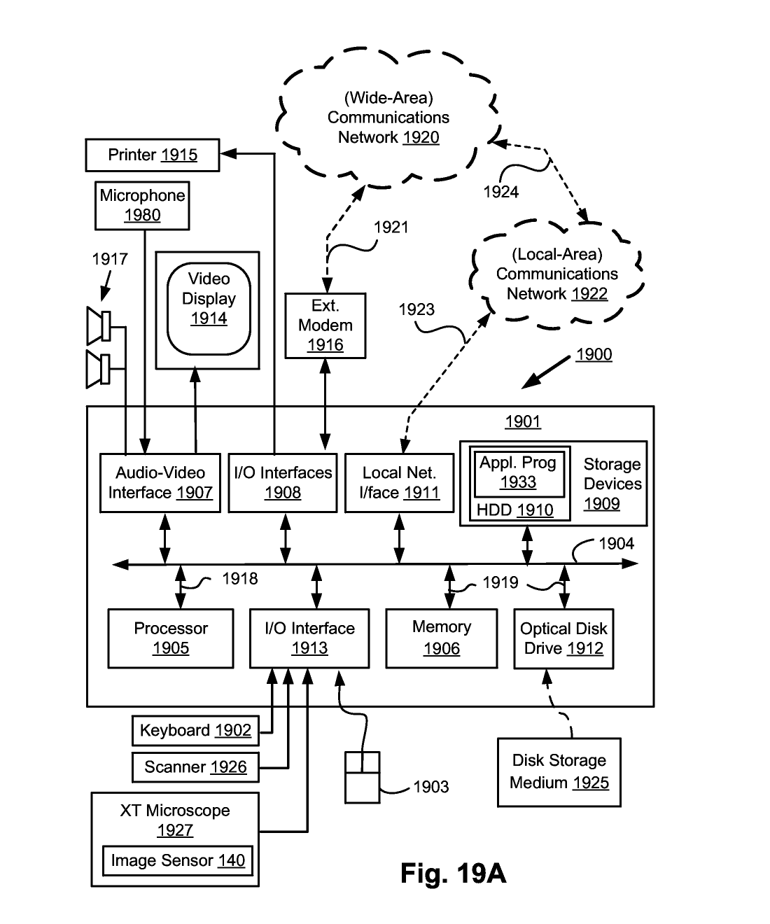

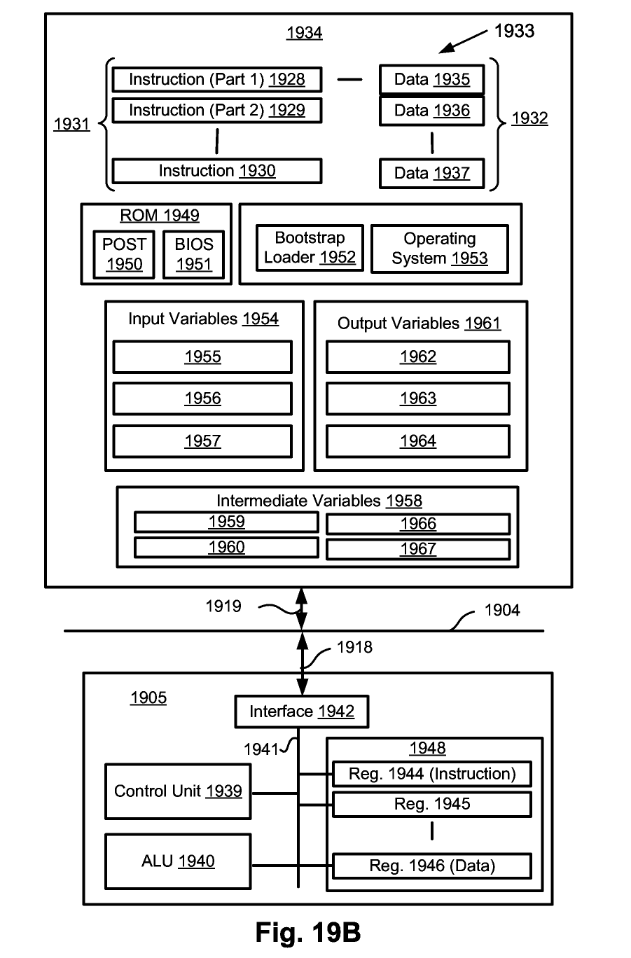

FIGS. 19A and 19B depict a general-purpose computer system 1900, upon which the various arrangements described can be practiced.

As seen in FIG. 19A, the computer system 1900 includes: a computer module 1901; input devices such as a keyboard 1902, a mouse pointer device 1903, a scanner 1926, an XT microscope 1927 incorporating the system 100 and particualrly the image sensor 140, and a microphone 1980; and output devices including a printer 1915, a display device 1914 and loudspeakers 1917. An external Modulator-Demodulator (Modem) transceiver device 1916 may be used by the computer module 1901 for communicating to and from a communications network 1920 via a connection 1921. The communications network 1920 may be a wide-area network (WAN), such as the Internet, a cellular telecommunications network, or a private WAN. Where the connection 1921 is a telephone line, the modem 1916 may be a traditional “dial-up” modem. Alternatively, where the connection 1921 is a high capacity (e.g., cable) connection, the modem 1916 may be a broadband modem. A wireless modem may also be used for wireless connection to the communications network 1920.

The computer module 1901 typically includes at least one processor unit 1905, and a memory unit 1906. For example, the memory unit 1906 may have semiconductor random access memory (RAM) and semiconductor read only memory (ROM). The computer module 1901 also includes an number of input/output (I/O) interfaces including: an audio-video interface 1907 that couples to the video display 1914, loudspeakers 1917 and microphone 1980; an I/O interface 1913 that couples to the keyboard 1902, mouse 1903, scanner 1926, XT microscope 1927 and optionally a joystick or other human interface device (not illustrated); and an interface 1908 for the external modem 1916 and printer 1915. In some implementations, the modem 1916 may be incorporated within the computer module 1901, for example within the interface 1908. The computer module 1901 also has a local network interface 1911, which permits coupling of the computer system 1900 via a connection 1923 to a local-area communications network 1922, known as a Local Area Network (LAN). As illustrated in FIG. 19A, the local communications network 1922 may also couple to the wide network 1920 via a connection 1924, which would typically include a so-called “firewall” device or device of similar functionality. The local network interface 1911 may comprise an Ethernet circuit card, a Bluetooth™ wireless arrangement or an IEEE 802.11 wireless arrangement; however, numerous other types of interfaces may be practiced for the interface 1911.

The I/O interfaces 1908 and 1913 may afford either or both of serial and parallel connectivity, the former typically being implemented according to the Universal Serial Bus (USB) standards and having corresponding USB connectors (not illustrated). Storage devices 1909 are provided and typically include a hard disk drive (HDD) 1910. Other storage devices such as a floppy disk drive and a magnetic tape drive (not illustrated) may also be used. An optical disk drive 1912 is typically provided to act as a non-volatile source of data. Portable memory devices, such optical disks (e.g., CD-ROM, DVD, Blu ray Disc™), USB-RAM, portable, external hard drives, and floppy disks, for example, may be used as appropriate sources of data to the system 1900.

The components 1905 to 1913 of the computer module 1901 typically communicate via an interconnected bus 1904 and in a manner that results in a conventional mode of operation of the computer system 1900 known to those in the relevant art. For example, the processor 1905 is coupled to the system bus 1904 using a connection 1918. Likewise, the memory 1906 and optical disk drive 1912 are coupled to the system bus 1904 by connections 1919. Examples of computers on which the described arrangements can be practised include IBM-PC's and compatibles, Sun Sparcstations, Apple Mac™ or a like computer systems.

The methods of fringe image processing including denoising may be implemented using the computer system 1900 wherein the processes of FIGS. 2 toll, to be described, may be implemented as one or more software application programs 1933 executable within the computer system 1900. In particular, images captured by the image sensor 140 of the XT microscope 1927 may be stored in the HDD 1910 as a permenant repository, and processed via temporary storage in the RAM 1906. The steps of the methods of image processing are effected by instructions 1931 (see FIG. 19B) in the software 1933 that are carried out within the computer system 1900. The software instructions 1931 may be formed as one or more code modules, each for performing one or more particular tasks. The software may also be divided into two separate parts, in which a first part and the corresponding code modules performs the image processing methods and a second part and the corresponding code modules manage a user interface between the first part and the user.

The software may be stored in a computer readable medium, including the storage devices described below, for example. The software is loaded into the computer system 1900 from the computer readable medium, and then executed by the computer system 1900. A computer readable medium having such software or computer program recorded on the computer readable medium is a computer program product. The use of the computer program product in the computer system 1900 preferably effects an advantageous apparatus for processing of fringe images.

The software 1933 is typically stored in the HDD 1910 or the memory 1906. The software is loaded into the computer system 1900 from a computer readable medium, and executed by the computer system 1900. Thus, for example, the software 1933 may be stored on an optically readable disk storage medium (e.g., CD-ROM) 1925 that is read by the optical disk drive 1912. A computer readable medium having such software or computer program recorded on it is a computer program product. The use of the computer program product in the computer system 1900 preferably effects an apparatus for processing fringe images.

In some instances, the application programs 1933 may be supplied to the user encoded on one or more CD-ROMs 1925 and read via the corresponding drive 1912, or alternatively may be read by the user from the networks 1920 or 1922. Still further, the software can also be loaded into the computer system 1900 from other computer readable media. Computer readable storage media refers to any non-transitory tangible storage medium that provides recorded instructions and/or data to the computer system 1900 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 1901. Examples of transitory or non-tangible computer readable transmission media that may also participate in the provision of software, application programs, instructions and/or data to the computer module 1901 include radio or infra-red transmission channels as well as a network connection to another computer or networked device, and the Internet or Intranets including e-mail transmissions and information recorded on Websites and the like.

The second part of the application programs 1933 and the corresponding code modules mentioned above may be executed to implement one or more graphical user interfaces (GUIs) to be rendered or otherwise represented upon the display 1914. Through manipulation of typically the keyboard 1902 and the mouse 1903, a user of the computer system 1900 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 1917 and user voice commands input via the microphone 1980.

FIG. 19B is a detailed schematic block diagram of the processor 1905 and a “memory” 1934. The memory 1934 represents a logical aggregation of all the memory modules (including the HDD 1909 and semiconductor memory 1906) that can be accessed by the computer module 1901 in FIG. 19A.

When the computer module 1901 is initially powered up, a power-on self-test (POST) program 1950 executes. The POST program 1950 is typically stored in a ROM 1949 of the semiconductor memory 1906 of FIG. 19A. A hardware device such as the ROM 1949 storing software is sometimes referred to as firmware. The POST program 1950 examines hardware within the computer module 1901 to ensure proper functioning and typically checks the processor 1905, the memory 1934 (1909, 1906), and a basic input-output systems software (BIOS) module 1951, also typically stored in the ROM 1949, for correct operation. Once the POST program 1950 has run successfully, the BIOS 1951 activates the hard disk drive 1910 of FIG. 19A. Activation of the hard disk drive 1910 causes a bootstrap loader program 1952 that is resident on the hard disk drive 1910 to execute via the processor 1905. This loads an operating system 1953 into the RAM memory 1906, upon which the operating system 1953 commences operation. The operating system 1953 is a system level application, executable by the processor 1905, to fulfil various high level functions, including processor management, memory management, device management, storage management, software application interface, and generic user interface.

The operating system 1953 manages the memory 1934 (1909, 1906) to ensure that each process or application running on the computer module 1901 has sufficient memory in which to execute without colliding with memory allocated to another process. Furthermore, the different types of memory available in the system 1900 of FIG. 19A must be used properly so that each process can run effectively. Accordingly, the aggregated memory 1934 is not intended to illustrate how particular segments of memory are allocated (unless otherwise stated), but rather to provide a general view of the memory accessible by the computer system 1900 and how such is used.

As shown in FIG. 19B, the processor 1905 includes a number of functional modules including a control unit 1939, an arithmetic logic unit (ALU) 1940, and a local or internal memory 1948, sometimes called a cache memory. The cache memory 1948 typically include a number of storage registers 1944-1946 in a register section. One or more internal busses 1941 functionally interconnect these functional modules. The processor 1905 typically also has one or more interfaces 1942 for communicating with external devices via the system bus 1904, using a connection 1918. The memory 1934 is coupled to the bus 1904 using a connection 1919.

The application program 1933 includes a sequence of instructions 1931 that may include conditional branch and loop instructions. The program 1933 may also include data 1932 which is used in execution of the program 1933. The instructions 1931 and the data 1932 are stored in memory locations 1928, 1929, 1930 and 1935, 1936, 1937, respectively. Depending upon the relative size of the instructions 1931 and the memory locations 1928-1930, a particular instruction may be stored in a single memory location as depicted by the instruction shown in the memory location 1930. Alternately, an instruction may be segmented into a number of parts each of which is stored in a separate memory location, as depicted by the instruction segments shown in the memory locations 1928 and 1929.

In general, the processor 1905 is given a set of instructions which are executed therein. The processor 1905 waits for a subsequent input, to which the processor 1905 reacts to by executing another set of instructions. Each input may be provided from one or more of a number of sources, including data generated by one or more of the input devices 1902, 1903, data received from an external source across one of the networks 1920, 1922, data retrieved from one of the storage devices 1906, 1909 or data retrieved from a storage medium 1925 inserted into the corresponding reader 1912, all depicted in FIG. 19A. The execution of a set of the instructions may in some cases result in output of data. Execution may also involve storing data or variables to the memory 1934.

The disclosed image processing arrangements use input variables 1954, which are stored in the memory 1934 in corresponding memory locations 1955, 1956, 1957. The image processing arrangements produce output variables 1961, which are stored in the memory 1934 in corresponding memory locations 1962, 1963, 1964. Intermediate variables 1958 may be stored in memory locations 1959, 1960, 1966 and 1967.

Referring to the processor 1905 of FIG. 19B, the registers 1944, 1945, 1946, the arithmetic logic unit (ALU) 1940, and the control unit 1939 work together to perform sequences of micro-operations needed to perform “fetch, decode, and execute” cycles for every instruction in the instruction set making up the program 1933. Each fetch, decode, and execute cycle comprises:
(i) a fetch operation, which fetches or reads an instruction 1931 from a memory location 1928, 1929, 1930;
(ii) a decode operation in which the control unit 1939 determines which instruction has been fetched; and
(iii) an execute operation in which the control unit 1939 and/or the ALU 1940 execute the instruction.

Thereafter, a further fetch, decode, and execute cycle for the next instruction may be executed. Similarly, a store cycle may be performed by which the control unit 1939 stores or writes a value to a memory location 1932.

Each step or sub-process in the processes of FIGS. 2-11 is associated with one or more segments of the program 1933 and is performed by the register section 1944, 1945, 1946, the ALU 1940, and the control unit 1939 in the processor 1905 working together to perform the fetch, decode, and execute cycles for every instruction in the instruction set for the noted segments of the program 1933.

### Overview

In order to achieve different denoising results for different noise strengths and different underlying modulated fringe images, presently disclosed is a wavelet denoising method that uses an adaptive wavelet thresholding function that is parameterized by the fringe frequency, the modulation strength of the fringes, and noise strength.

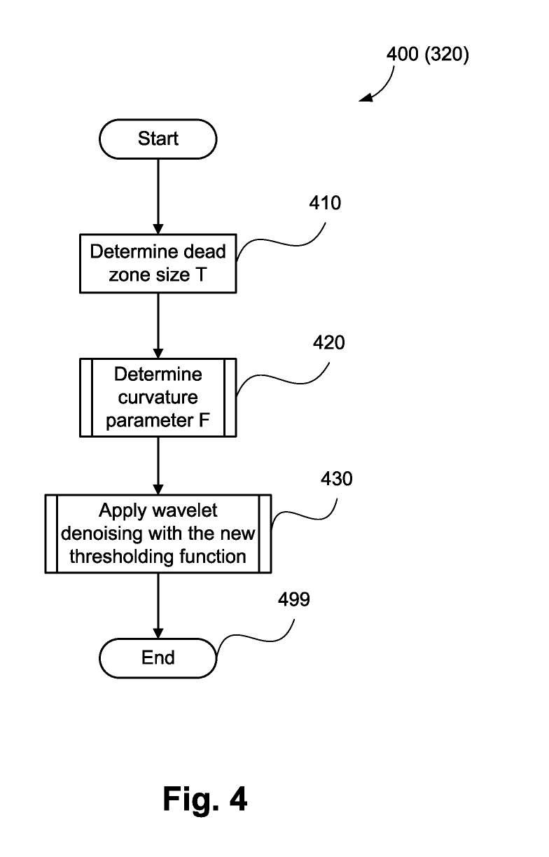

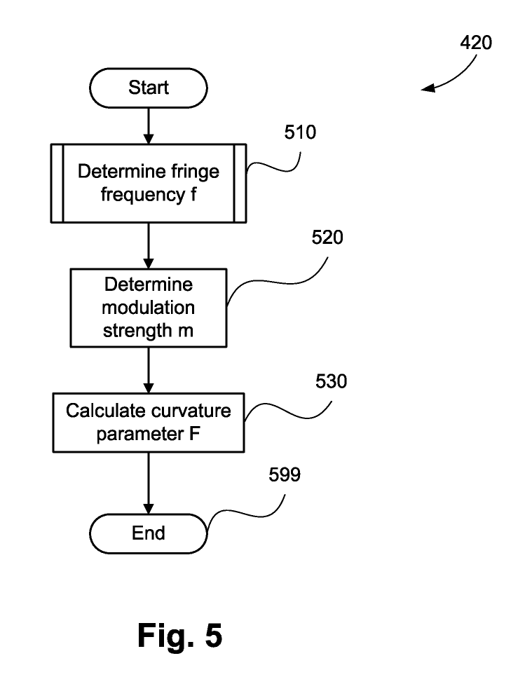

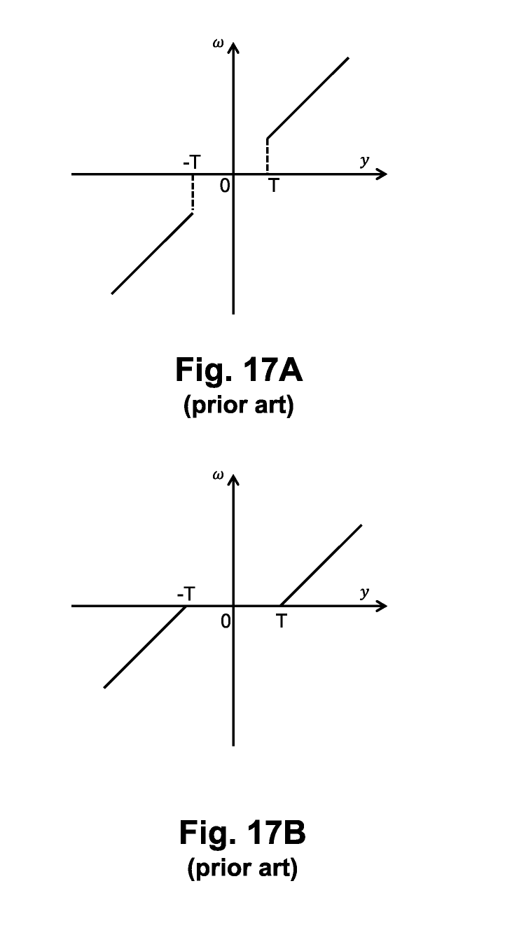

FIG. 4 is a flowchart of a wavelet denoising method 400 according to the present disclosure and which may be used as the denoising 320 of FIG. 3. The method 400, as is the method 300, is preferably implemented as the software application 1933 executable by the processor 1905 of the computer 1901 to process images captured by the image sensor 140. A first step 410 of the method 400 determines the value of a ‘dead zone size’ T, generally described above with reference to FIGS. 17A and 17B. Step 420 then determines a ‘curvature parameter’ F, that modifies the slope of the thresholding function to thereby represent an adaptive thresholding function, and step 430 applies wavelet denoising to the adaptive thresholding function with dead zone size T and the curvature parameter F. Note that curvature parameter F merely affects a curvature of the thresholding function and may not directly correspond to the curvature of the thresholding (or mapping) function. Details of calculation of the dead zone size T performed in step 410 will be explained later. Details of the curvature parameter F calculation performed in step 420 will be discussed with reference to FIG. 5.

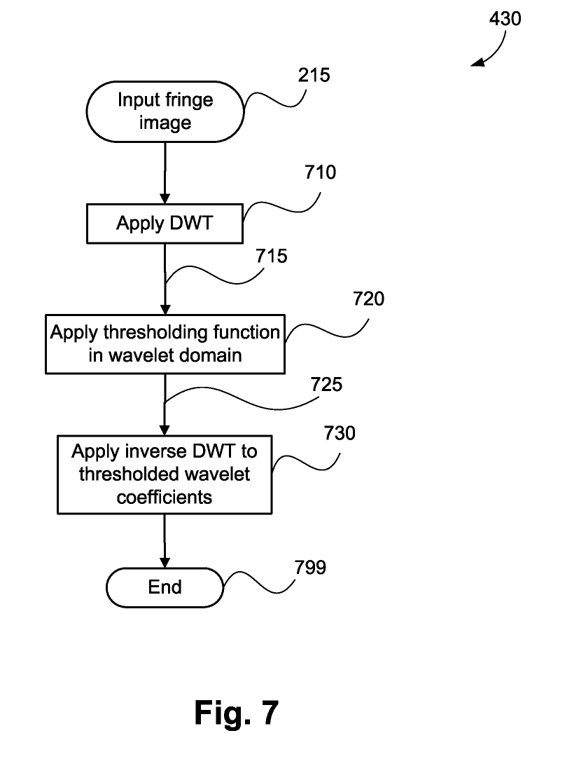

Step 430, being the applying of wavelet denoising with a new adaptive thresholding function, can be explained with reference to FIG. 7. Step 710 applies discrete wavelet transform (DWT) to obtain a group of wavelet coefficients 715 of the noisy input fringe image 215. Step 720 then applies the adaptive thresholding function in the wavelet domain to shrink some of the wavelet coefficients determined from step 710 to form thresholded wavelet coefficients 725. Step 730 then inverse transforms the thresholded (shrunk) wavelet coefficients 725 from the wavelet domain back to the spatial domain.

A wavelet thresholding function is a mapping relationship between noisy wavelet coefficients and the denoised wavelet coefficients. The wavelet coefficients mapping function has a rate of change that varies depending at least on the carrier frequency component of the captured fringe pattern.

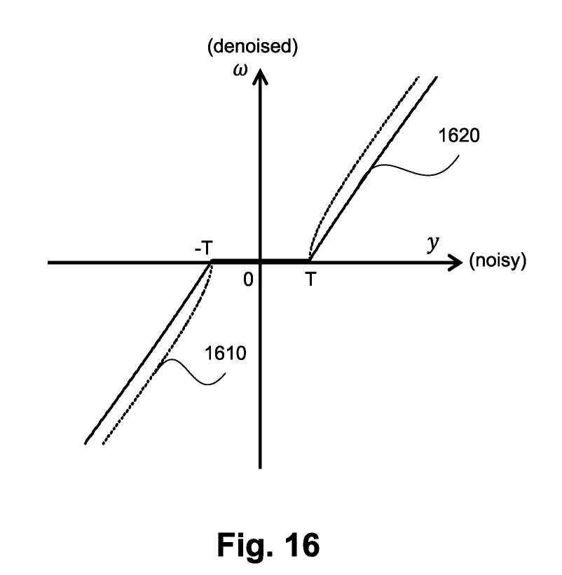

FIG. 16 shows an example of the aforementioned adaptive thresholding function with different curvature parameter values and the same dead zone size. The curvature of the function affords the desired varying or variable rate of change. In FIG. 16, the horizontal axis labelled y represents the noisy wavelet coefficients 715 obtained from step 710, and the vertical axis labelled ω represents the denoised wavelet coefficients 725 output from step 720. A dotted line 1610, which spans the ω and y axes represents a first mapping function with dead zone size T and curvature parameter F₁. The solid line 1620 represents a second mapping function with the same dead zone size T and curvature parameter F₂. Note that the curvature parameter F₂ of the second mapping function 1620 is very large, giving the function 1620 an almost linear appearance (indicated by the somewhat jaggedness of the illustrated line of the function), whilst acknowledging that in each the prior art denoising functions of FIGS. 17A and 17B, each is linear beyond the dead zone T (indicated by a smooth illustrated line of the function). The application of the thresholding function, e.g. 1610 or 1620, to the wavelet coefficients 715 results in a transforming of the coefficients 715 into denoised coefficients 725.

The thresholding function (e.g. 1610, 1620) depicted in FIG. 16 can be expressed with:

$$ω = \{ \begin{matrix}\frac{T * y - sgn ( y ) F + sgn ( y ) \sqrt{{[ sgn ( y ) F + T * y ]}^{2} - 4 {T}^{2} F}}{2 T} & \vert y \vert \geq T > 0 \\ 0 , & otherwise\end{matrix} \qquad ( 3 )$$

where T is the dead zone size and F is a curvature parameter that changes the shape of the function. The function in Equation (3) can be interpreted using an expression:

$$y = \{ \begin{matrix}ω + \frac{T * F}{ω * T + sgn ( ω ) * F} & \vert w \vert > 0 \\ \pm T , & otherwise\end{matrix} \qquad ( 4 )$$

where ‘*’ indicates multiplication. Note that solving Equation (4) for ω will result in Equation (3). Equation (4) provides a simple and more convenient way of describing the mapping from the noisy wavelet coefficients y to the denoised wavelet coefficients ω. In Equations (3) and (4), sgn(x)=1 where x>0 and sgn(x)=−1 where x<0. The value of sgn(0) is undefined as it is not necessary. Note that Equation (4) corresponds to the mapping from the noisy wavelet coefficients y to the denoised wavelet coefficients ω even though the equation format suggests a mapping from ω to y. Therefore, regardless of the fact that equation (4) cannot be formally called “a function”, the mapping from the noisy wavelet coefficients y to the denoised wavelet coefficients ω performed by solving Equation (4) can be considered as a mapping function for purposes of the present disclosure. By carefully choosing the curvature parameter F and the dead zone size T, the thresholding function in Equation (3) provides a flexible mapping that adapts to fringe images with different fringe frequencies, modulation strength, and noise strength. As will be appreciated from Equations (3) and (4), the rate of change of the established wavelet coefficients mapping function 1610, 1620 is non-linearly dependent on the carrier frequency component of the fringe pattern. Moreover, the rate of change of the established wavelet coefficients mapping function determines a suppressing rate for the wavelet coefficients with a magnitude outside the predetermined range. These attributes will be appreciated, at least qualitatively from FIG. 16 and the illustrated curvature of the mapping function 1610 beyond the dead zone T, which is somewhat inversely exponential adjacent the dead zone T and becomes linear away from the dead zone T.

In FIG. 16, the two illustrated thresholding functions 1610 and 1620 have the same dead zone size T. Any noisy wavelet coefficients that fall in the dead zone will be set to zero. In other words, small wavelet coefficients in the noisy image are considered noise and are removed. The value of the dead zone size T determines which coefficients are considered noise and which coefficients are considered to represent the clean signal desired to be recovered.

Meanwhile, the dotted line 1610 in FIG. 16 represents a mapping function formed using a small value of the curvature parameter (F₁), and the solid line 1620 represents a mapping function determined based on a large value of the curvature parameter (F₂). That is, F₁<F₂. The curvature parameter F determines the shape of the thresholding function. When F is small, as in the function 1610, the coefficients outside of the dead zone are well preserved as the values of these coefficients will be mapped to values close to their original values. When F is large, as in the function 1620, the coefficients outside of the dead zone are shrunk more towards zero, particularly when compared to the function 1610, i.e., the coefficients that are considered clean signal will be treated more similarly to noise. In other words, the curvature parameter F determines how differently noise and clean signal are treated in the mapping process.

These arrangements present described provide an adaptive wavelet denoising framework that relies on good choices of dead zone size and curvature parameter that fit the signal to noise (SNR) level, fringe frequency, and modulation strength of an input fringe image.

### First Implementation

Referring back to FIG. 4, step 410 determines the size T of the dead zone shown in FIG. 16. This parameter tunes the denoising level according to the noise strength. For example, T can be calculated using

T=σₙ\sqrt{2logL}

where σₙ is the standard deviation of the additive white Gaussian noise, and L is the total number of pixels in the noisy captured fringe pattern image. The standard deviation of the noise σₙ can be estimated using the median value of pixels in one part of the image. As such, the range of the magnitude value T is determined based on estimated noise variance in the captured fringe pattern.

In step 420, the processor 1905 calculates a curvature parameter F that varies the shape of the thresholding function described in Equation (3). A smaller curvature parameter gives a thresholding function such as the function 1610, which shrinks the signals less, while a larger curvature parameter gives a thresholding function 1620, which shrinks the signals more. It should be noted that the dead zone size T and the curvature parameter F are determined independently and separately.

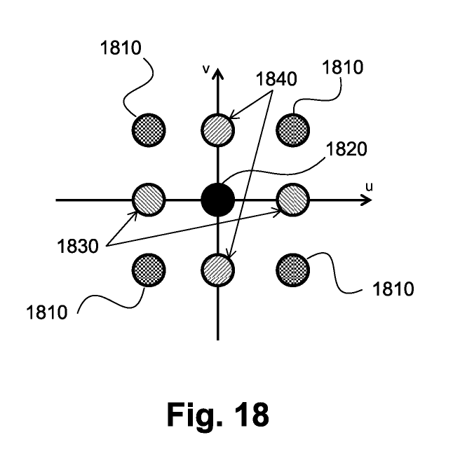

Details of Step 420 are now discussed with reference to FIG. 5. In FIG. 5, in an initial step 510, the processor 1905 operates to calculate the fringe frequency of the captured fringe image 215. Because there is a strong periodical signal (the fringe) in the captured image 215, there should be a strong peak in the Fourier representation of the fringe image 215. FIG. 18 illustrates the relative locations of x and y frequency peaks, and the DC component 1820 of the Fourier representation of a fringe image 215. Specifically seen in FIG. 18 are x frequency peaks 1830 and y frequency peaks 1840, and cross terms 1810 that represent the interaction between x and y peaks 1830, 1840. Once the peak location is identified in the Fourier domain, the fringe frequency can be deduced from the distance between the peak and the DC component.

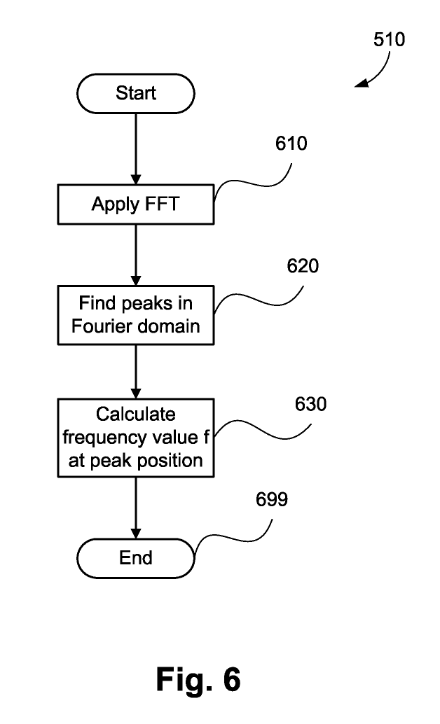

The process 510 for determining the fringe frequency is briefly described in FIG. 6, where step 610 applies a Fast Fourier Transform (FFT) to the fringe image 215, step 620 finds peaks in the Fourier domain, and step 630 calculates the fringe frequency value f. Identification of the peaks may be performed, for example, according to the approach disclosed in International Patent Publication No. WO 03/052676 (PCT/AU2002/01714). There are many existing peak finding algorithms that can be used in step 620. For example, to find out the x and y peaks 1830 and 1840 in FIG. 18, the 25 highest values in Fourier domain can be located using thresholding. A sub-signal can then be formed around each of these 25 values by selecting an 11-by-11 pixel region centred at each of the 25 values from the Fourier representation of the fringe image. Each of these sub-signals is then up-sampled using Fourier interpolation and a refined peak location is found for each of the sub-signals. The five highest values are then chosen from these refined peaks to be the five peaks representing the x 1830, y 1840 and DC 1820 components in the original captured XT images 215. The distance between one of the x frequency components 1830 and the DC component 1820 is used as the fringe frequency value fₓ. The distance between one of the y frequency components 1840 and the DC component 1820 is used as the fringe frequency value f_{y}.

In this first implementation, the horizontal and vertical fringe frequency components are assumed to be the same, that is, fₓ=f_{y}, due to the use of regular gratings, such as those illustrated in FIGS. 15A and 15B. In practice, only the horizontal fringe frequency component fₓ is calculated. This calculated fringe frequency is referred to as the fringe frequency value f.

Once the fringe frequency value f is determined, the process in FIG. 5 calculates the modulation strength in step 520. The modulation strength mₓ or m_{y} (see Equation (1)) is extracted in a rough demodulation process similar to the one described in step 220. That is, a rough modulation process is performed to obtain an estimate of the modulation strength mₓ and m_{y}. The purpose of this rough modulation is not to recover the object information (as in step 220), but to help determine the curvature parameter F, as F is dependent on the fringe frequency and the modulation strength of the captured fringe image. The estimated fringe frequency value f calculated in step 510 is used in the aforementioned rough demodulation process as part of the modulation strength extraction. In this implementation, the x and y modulation strength mₓ and m_{y} are assumed to be the same. Therefore, only the horizontal modulation strength mₓ is extracted, although the vertical modulation strength m_{y} is available as part of the demodulation results. Recall that the demodulation process of step 220 produces five outputs: absorption factor a(r), x modulation strength mₓ(r), y modulation strength m_{y}(r), x differential phase ξₓ(r) and y differential phase ξ_{y}(r). The calculated modulation strength mₓ in step 520 will be referred to as the modulation strength m.

Once the fringe frequency f and the modulation strength m are calculated, the curvature parameter F can be determined in step 530. Because the captured fringe image is dominated by a one-dimensional or two-dimensional fringe, there is significant energy concentrated at the location of the fringe frequency in the Fourier domain. Naturally, the denoising process needs to handle the fringe frequency carefully to avoid visible damage to the fringe. It is therefore understandable that the fringe frequency f plays a role in how differently noise and signal are treated. In other words, the fringe frequency value f will have an impact on the curvature parameter F, as F determines how differently noise and signal are treated in the wavelet domain. Generally, when the fringe frequency f is low (i.e. a wide fringe), signal and noise should be shrunk at very different levels because signal and noise in this case are well separated in frequency domain. There is little risk of accidentally removing a considerable amount of signal while removing noise. If, however, the fringe frequency f is high (i.e. a narrow fringe), the boundary of signal and noise in frequency domain is not very clear, which makes it more risky for the thresholding function to suppress certain wavelet coefficients, even if the dead zone size T is carefully selected.

In summary, a captured image with low fringe frequency (wide fringe) should be denoised with a thresholding function with a small F like the function 1610 due to high confidence in the dead zone size T. A captured image with high fringe frequency (narrow fringe) should be denoised with a thresholding function with large F like the function 1620 to control the damage in the clean signal or to avoid boosting noise in case the dead zone size T is not accurate enough. That is, the curvature parameter F should be proportional to the fringe frequency: a low fringe frequency requires a small curvature parameter and a high fringe frequency requires a large curvature parameter.

Meanwhile, the modulation strength m determines the percentage of energy in the captured image that comes from the fringe and from the object. Therefore, the modulation strength also has an impact on the choice of the curvature parameter F. If the fringe is strongly modulated by the object information, only a small part of the signal energy comes from the fringe and the rest is from the object information. This means the peaks representing the fringe in Fourier domain will have small amplitudes and consequently small impact on the quality of the image denoising results. If, however, the modulation strength is relatively weak, the fringe dominates the whole image, more care needs to be taken towards shrinking the coefficients. That is, with a strong modulation, a small curvature parameter F can be used while a large curvature parameter is more suitable for captured images with weak modulation.

Step 530 calculates a curvature parameter F according to the fringe frequency f and the modulation strength m. The curvature parameter is calculated by interpolating values in a pre-generated look-up table. Details of the interpolation process will be explained with an example later. Generally, any linear or higher order interpolation is feasible.

The look-up table used in step 530 is generated using at least two standard or customized training images. Since a general correlation between the fringe frequency f, the modulation strength m, and the curvature parameter F is assumed for the system 100 with the gratings G0, G1 and G2, one only needs to generate the look-up table once. Whenever a new curvature parameter F is required, a simple linear or higher order interpolation can be performed.

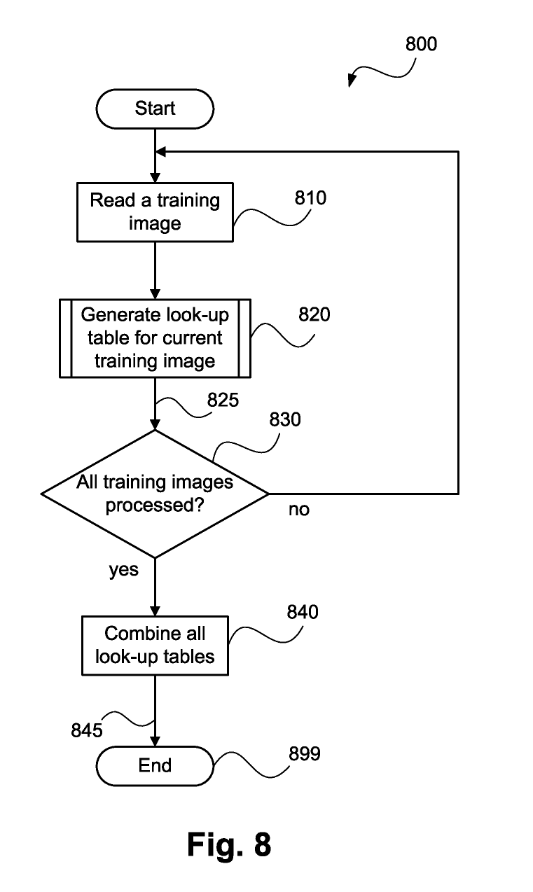

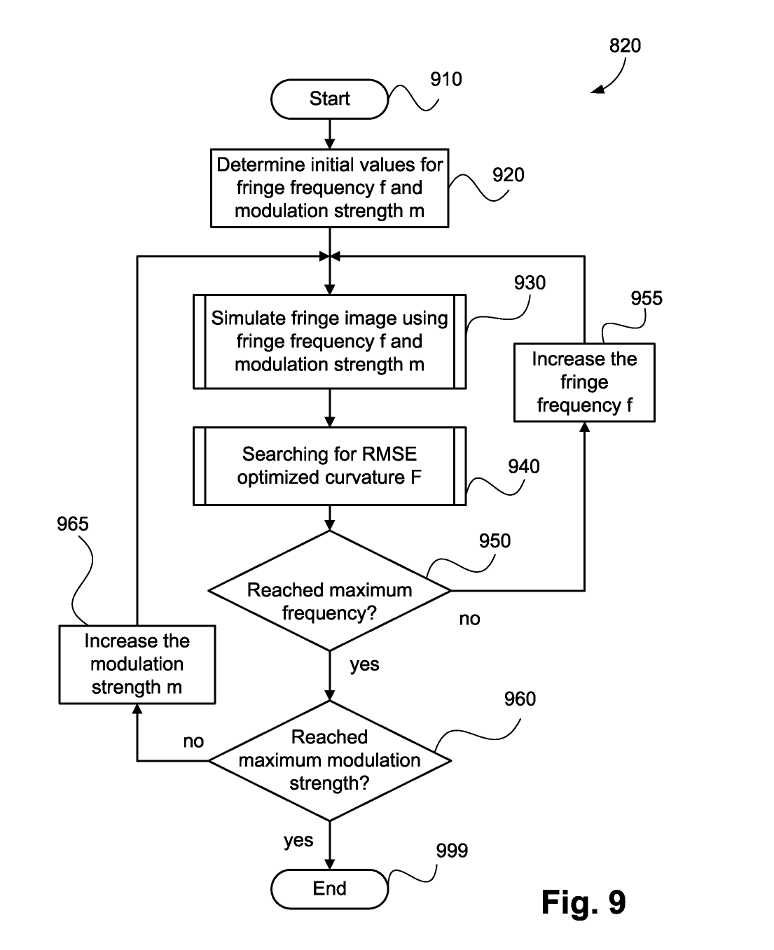

FIG. 8 explains a preferred look-up table generation process 800 in detail. The process 800 is also preferably implemented by software as an application executable by the processor 1095 in the computer 1901. Step 810 reads in a training image from a collection of optical path length images. These optical path length images can be formed from an artificial image or something simulated from a regular X-ray (absorption) image. Such images also do not have to reflect a real optical path length precisely. The optical path length images just need to include a few reasonable transitions between dark and light regions. Step 820 generates a look-up table 825 for the current training image. Step 830 then checks if all training images in the collection of optical path length images have been processed and, if not, the flow of the method 800 returns to step 810 to read the next training image. When all training images have been processed, each of the generated look-up tables 825 are combined to produce a general look-up table 845 in step 840. Details of step 820 will be described with reference to FIG. 9.

The training images in step 810 are optical path length (OPL) images that represent the phase change of the optical wave along its propagation path. For example, in a medium with constant refractive index, the optical path length can be expressed as OPL=d*n, where d is the physical distance the ray travelled and n is the refractive index of the medium. If the wavelength λ of the optical wave is known, the phase change of this wave while travelling in the medium can be calculated as

$$2 π \frac{OPL}{λ} .$$

These optical path length images can be either artificially created or simulated from a real X-ray absorption image. For example, an optical path length image can be created by taking the logarithm of a regular X-ray absorption image.

FIG. 9 gives the detail of a preferred form of the look-up table generation step 820 in FIG. 8. Generating a look-up table for the curvature parameter F means determining the relationship between the fringe frequency f, the modulation strength m and the curvature parameter F. In other words, the curvature parameter F is a function of the fringe frequency f and the modulation strength m. The preferred approach shown in FIG. 9 uses the curvature parameter F that produces a denoised result with minimum RMSE (root mean square error), calculated using the denoised result and the ground truth, with a certain dead zone size T. Because it is difficult to find the global minimum of the RMSE with respect to all values of F, a local minimum is used. It is possible that the local minimum is also the global minimum.

In FIG. 9, in step 920 the processor 1905 determines the initial values for fringe frequency f and modulation strength m in order to generate the look-up table. In this implementation, an initial fringe frequency f₀=64 pixels per fringe and an initial modulation strength value m₀=0.4 are selected. The initial fringe frequency and the initial modulation strength are chosen according to the common set-up of an X-ray Talbot imaging system, such as shown in FIG. 1. Step 930 then simulates a noisy fringe image based on the training image read in step 810. In step 940, a curvature parameter F is determined by the processor 1905 for the particular values of f and m. Details of steps 930 and 940 will be discussed later. Step 950 then checks the current fringe frequency value. Where the current fringe frequency has not reached a predetermined maximum frequency—8 pixels per fringe, the process of step 820 goes to step 955 to increase the fringe frequency f by halving the number of pixels per fringe. For example, if the current fringe frequency is 64 pixels per fringe, the new frequency after step 955 will be 32 pixels per fringe. Frequency should really be measured and expressed as “fringes per pixel”. However, it is convenient in the present case to use “pixels per fringe” as the numbers generally encountered in reality are (conveniently) 64, 32, 16, 8, 6 etc. This means that the higher the frequency, the lower the number: 8 pixels per fringe is a higher frequency than 16 pixels per fringe.

Similarly, step 960 checks if the current modulation strength m is greater than a predetermined maximum value—0.8. This maximum number is determined as empirical value from the real system. If not, the process goes to step 965 to increase the modulation strength by 0.1. For example, if the currently modulation strength is 0.4, the new modulation strength after step 965 will be 0.5. If both maximum fringe frequency and maximum modulation strength are reached, the look-up table for the current training image is done. The maximum modulation strength is also an empirical value. The maximum frequency rarely goes over 8 pixels per fringe and the maximum modulation almost never goes over 0.8. This is certainly true for XT systems, but also true for many modulation systems. Because simulations discussed in the preferred implementations aim to cover situations in real experiments, it is safe to assume these upper limits.

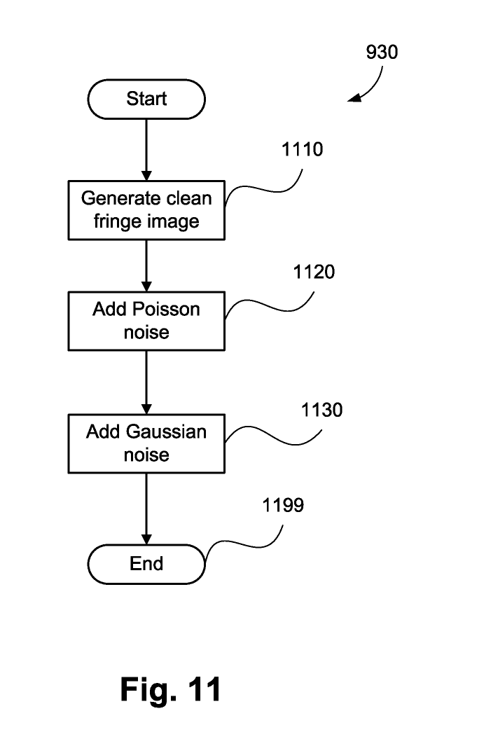

The details of the noisy fringe image simulation performed in step 930 are explained with reference to FIG. 11. Step 1110 generates a clean fringe image using Equations (1) and (2) noted above, and reproduced again below:

z(r)=¼a(r)(1+mₓ(r)cos(φₓ(r)))(1+m_{y}(r)cos(φ_{y}(r))) (1)

where

$${φ}_{x} ( r ) = 2 π {xf}_{x} + \frac{\partial ψ}{\partial x} ( r ) and {φ}_{y} ( r ) = 2 π {yf}_{y} + \frac{\partial ψ}{\partial y} ( r )$$

In Equation (2), ψ represents the training OPL image, which varies as a function of position r. Since the x fringe frequency fₓ and the y fringe frequency f_{y} are assumed to be the same, and the x modulation strength mₓ and the y modulation strength m_{y} are also assumed to be the same, the simulation of clean fringe image is implemented as:

z(r)=¼a(1+m cos(φₓ(r)))(1+m cos(φ_{y}(r)))

where

$${φ}_{x} ( r ) = 2 π {xf}_{x} + \frac{\partial ψ}{\partial x} ( r ) and {φ}_{y} ( r ) = 2 π {yf}_{y} + \frac{\partial ψ}{\partial y} ( r ) \qquad ( 5 )$$

The f and m in Equation (5) are the current fringe frequency and the current modulation strength respectively. For example, the fringe frequency can be the initial frequency f₀=64 pixels per fringe and the modulation strength can be the initial modulation strength m₀=0.4. Notice that in Equation (5), the absorption factor a has been simplified to be a constant across the image, since the value of the absorption does not affect the RMSE, thus does not affect the choice of the curvature parameter F. For example, a can be set to 1.

In order to assess the denoising results with a particular curvature parameter F, certain noise is added to the generated fringe image in each of steps 1120 and 1130. Step 1120 is configured to add Poisson noise, and step 1130 to add Gaussian noise. Because the noise level of the simulated image will not directly affect the choice of the curvature parameter F, the Poisson and Gaussian noise added in FIG. 11 can have any noise strength that is reasonable. For example, the signal to noise ratio of the Poisson and Gaussian noise can be both set to 35 dB. This is also an empirical value that represents the average image quality in the XT system. The present inventor has found that any value between 30 to 40 dB is within the right range and is usable. 35 dB is the signal to noise ratio for both Poisson and Gaussian noise.

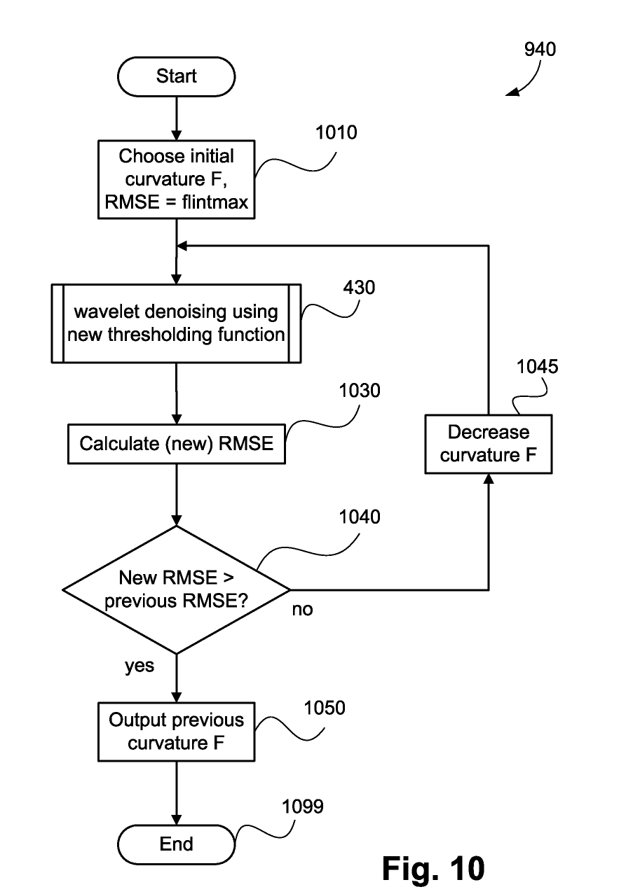

Details of a preferred implementation of step 940 are discussed with reference to FIG. 10. Step 940 attempts to denoise using a range of values for the curvature parameter F and search for the value of F adapted for a current fringe image based on the root mean square error (RMSE). In FIG. 10, in an initial step 1010, the processor 1905 chooses an initial curvature parameter F and sets the initial RMSE to an initial large value (flintmax), such as 32767 for images with pixel values in the range [0, 255]. The initial curvature parameter F is set to a large number such as 10. This is also an empirical value that makes the curve in FIG. 16 look linear, like the curve 1620. Where F is too large, the curve will approaching the soft thresholding function, where it makes more sense to use just soft thresholding, not a complex function like Equation (3) or (4). The idea behind the particular thresholding function in Equation (3) or (4) is to provide something that varies smoothly between hard and soft thresholding functions, while providing an extra degree of freedom, for example where the dead zone size and the curvature parameter are determined separately. This contrasts prior art arrangements where the dead zone size and the curvature are strongly correlated, providing no ability to discriminate between high frequency fringes and low frequency fringes.

Note that when the value of F is large, the desired thresholding function in FIG. 16 (e.g. 1620) is approaching the soft thresholding function (FIG. 17B) while a smaller value of F gives a thresholding function (e.g. 1610) closer to the hard thresholding function (FIG. 17A). After the initial values of F and the RMSE are determined, the next step applies the wavelet shrinkage method with the new thresholding function in Equation (3) and obtains a denoised image. This step is the same as step 430 described above with reference to FIGS. 4 and 7, where the standard wavelet shrinkage is applied with the new thresholding function. Note that the dead zone size T used in the wavelet denoising step 430 of FIG. 10 is determined using noise strength, as discussed in step 410. The RMSE is then calculated in step 1030 by the processor 1905 using the difference between the denoised image and the ground truth image. The ground truth image comes from the modulated version of the original training image (original optical path length image). In other words, the ground truth image is that which is the output of step 1110 in FIG. 11. The (new) RMSE, being that calculated in step 1030 is then compared to the previous RMSE in step 1040. If the new RMSE is greater than the previous RMSE, the previous curvature parameter F becomes the curvature parameter of interest for the current training image as established at step 1050 and the search for RMSE optimized F for the current training image concludes at step 1099. If the new RMSE is smaller than the previous RMSE, the search continues to step 1045 where the processor 1905 decreases the curvature parameter F by 0.1, and returns the process 940 to the wavelet shrinkage process of step 430. The search implemented by the process loop of steps 430, 1030, 1040 and 1045 only stops when a local minimum is found. The local minimum is when the RMSE starts to increase after decreasing for several iterations. However, it is possible that no local minima exist for 0<F<10, in which case a lower limit for F is set to 1. That is, if the condition in step 1040 is not satisfied by the time F=1, the search stops and F=1 becomes the curvature parameter in step 1050.

There is a reason for starting the search with a relatively large value for F. By starting with a soft-thresholding-like curve, the algorithm is more likely to produce a tolerant yet less accurate algorithm. This will ensure that the fringe frequency, however high or low it is, will not suffer unstable damage. Ultimately, this will help avoid errors caused by incorrect estimation of the fringe frequency in later demodulation processes to recover the object information from a fringe image.

After the look-up table 825 is generated for the current training image, the process 800 in FIG. 8 goes to process more training images, as determined at step 830. The number of training images need not be large. For example, the present inventors have found that five training images are generally enough to achieve a sufficient selection of curvature parameters for denoising. For example, if 5 modulation strength values and 4 fringe frequency values are tested for each of the 5 training images, 5×4×5=100 values for the curvature parameter are calculated. Step 840 combines all the look-up tables by averaging corresponding values for all 5 training images. This is effective because the tables tend to have similar values of F. For example, the look-up table for a particular training image I₁ might look like Table 1:

TABLE 1
Look-up table for the first training image

| | m | | | | |
|---|---|---|---|---|---|
| f | 0.4 | 0.5 | 0.6 | 0.7 | 0.8 |
| 8 pixels/fringe | 4 | 4 | 3.8 | 3.9 | 4 |
| 16 pixels/fringe | 3.9 | 3.9 | 3.8 | 3.9 | 3.8 |
| 32 pixels/fringe | 3.7 | 3.6 | 3.6 | 3.6 | 3.5 |
| 64 pixels/fringe | 3.3 | 3.3 | 3.2 | 3.2 | 3.1 |

The look-up table for another training image I₂ might look like Table 2:

TABLE 2
Look-up table for the second training image

| | m | | | | |
|---|---|---|---|---|---|
| f | 0.4 | 0.5 | 0.6 | 0.7 | 0.8 |
| 8 pixels/fringe | 3.9 | 3.7 | 3.6 | 3.8 | 3.6 |
| 16 pixels/fringe | 3.7 | 3.6 | 3.6 | 3.5 | 3.4 |
| 32 pixels/fringe | 3.6 | 3.6 | 3.5 | 3.3 | 3.3 |
| 64 pixels/fringe | 3.3 | 3.3 | 3.1 | 3.2 | 3.1 |

The combined look-up table, assuming only two training images are used, will be as shown in Table 3:

TABLE 3
Combined look-up table

| | m | | | | |
|---|---|---|---|---|---|
| f | 0.4 | 0.5 | 0.6 | 0.7 | 0.8 |
| 8 pixels/fringe | 3.95 | 3.85 | 3.7 | 3.85 | 3.8 |
| 16 pixels/fringe | 3.8 | 3.75 | 3.7 | 3.7 | 3.6 |
| 32 pixels/fringe | 3.65 | 3.6 | 3.55 | 3.45 | 3.4 |
| 64 pixels/fringe | 3.3 | 3.3 | 3.15 | 3.2 | 3.1 |

Once the combined look-up table 845 is generated in step 840, any combination of the fringe frequency f and the modulation strength m can be used to calculate a curvature parameter value F suitable for particular fringe frequency and modulation strength. Using Table 3 as the example combined look-up table 845, when the input fringe image has a fringe frequency of 24 pixels per fringe (as calculated in step 510) and a modulation strength of 0.66 (as calculated in step 520), the curvature parameter of interest can be interpolated by the processor 1905 using the values from Table 3: F(16, 0.6)=3.7, F(16, 0.7)=3.7, F(32, 0.6)=3.55, F(32, 0.7)=3.45, where F(f, m) is the value of F with fringe frequency f and modulation strength m. A bilinear interpolation method can be used to calculate the appropriate value of the curvature parameter F. In this example, the interpolated curvature parameter F=3.595.

From Table 3, it will be appreciated that the wavelet coefficients mapping function is seen to vary depending on the carrier frequency component of the captured fringe pattern. Further, it will be appreciated that the mapping function operates to suppress the wavelet coefficients in accordance with the carrier frequency component of the captured fringe pattern, and particularly where the suppressing rate increases with increasing the carrier frequency of the captured fringe pattern—the values of F are larger for higher frequencies.

Once the dead zone size T (as calculated in step 410) and the curvature parameter F are determined, the proposed wavelet denoising method with the new adaptive thresholding function as described in Equation (3) is applied by the processor 1905 in step 430 and the noisy image is denoised.

In some implementations, the adaptive thresholding function can be expressed as:

$$ω = \{ \begin{matrix}y - sgn ( y ) * T + sgn ( y ) * f ( y , F ) & \vert y \vert \geq T > 0 \\ 0 , & otherwise\end{matrix} \qquad ( 6 )$$

In Equation (6), T is the dead zone size and F is the curvature parameter. The function f (y, F) is a smooth non-linear function and T≧f (y, F)≧0, i.e. when y approaches T, the function f (y, F) approaches 0; and when y approaches infinity, the function f (y, F) approaches T. Therefore, the non-linearly thresholding function as per Equation (6) is bounded by the soft and hard thresholding functions and varying based on the determined carrier frequency f and the modulation strength m, providing that the curvature parameter F is non-linearly dependent on the fringe (carrier) frequency f and the modulation strength m of the system. The adaptive thresholding function (6) behaves similarly to either a soft or hard thresholding function depending on the value of F. The choice of value for F is non-linearly dependent on the fringe frequency and the modulation strength of the system.

### Second Implementation

This implementation describes a denoising method using the same wavelet shrinkage framework as described above in the first implementation while the input fringe image does not have isotropic fringe frequency or isotropic modulation strength. In other words, fₓ≠f_{y} and mₓ≠m_{y}. In this case, one cannot use a single fringe frequency f and a single modulation strength m to construct the look-up table (845) for the curvature parameter F.

This means that each curvature parameter F in the look-up table is a function of four values, fₓ, f_{y}, mₓ and my_{y}, instead of two. Therefore, when generating the look-up table, different combinations of these four values need to be considered and the look-up table will be a four-dimensional table.

This will mainly affect the look-up table generation step in FIG. 9, especially step 940, where a search for RMSE optimized curvature parameter F is now required to traverse a four-dimensional matrix instead of a two-dimensional matrix.

The calculation of the curvature parameter for a particular noisy input image, as performed at step 530, is also affected due to the interpolation dimension change. That is, a quadrilinear interpolation is needed.

Once this four-dimensional look-up table is generated, the noise strength of an input fringe can be analysed to generate an appropriate dead zone size T; the x and y fringe frequency fₓ, f_{y} and the x and y modulation strength mₓ, m_{y} can be used to find an appropriate curvature parameter F by interpolating the values in the look-up table. Then the wavelet shrinkage process 430, seen in FIG. 7 of the first implementation can be applied to get an estimate of the clean fringe image.

### INDUSTRIAL APPLICABILITY

The arrangements described are applicable to the computer and data processing industries and particularly for the processing of images obtained from x-ray Talbot interferometry.

The foregoing describes only some embodiments of the present invention, and modifications and/or changes can be made thereto without departing from the scope and spirit of the invention, the embodiments being illustrative and not restrictive.

We claim:

1. An image de-noising method, the method comprising:
capturing a fringe pattern from an energy source, the captured fringe pattern having a carrier frequency component dependent on settings of the energy source;
obtaining wavelet coefficients for the captured fringe pattern by applying a wavelet transform to the captured fringe pattern;
establishing a wavelet coefficients mapping function having a rate of change that varies depending at least on the carrier frequency component of the captured fringe pattern;
transforming the obtained wavelet coefficients using the established wavelet coefficients mapping function; and
de-noising the captured fringe pattern by applying inverse wavelet transform to the transformed wavelet coefficients to form a denoised fringe pattern.

2. The method according to claim 1, further comprises demodulating the captured fringe pattern to determine at least the carrier frequency component and a modulation strength to which the fringe pattern is modulated by an object being imaged using the energy source.

3. The method according to claim 2, wherein the established wavelet coefficients mapping function is further based on the determined modulation strength.

4. The method according to claim 2, further comprises demodulating the denoised fringe pattern using the determined carrier frequency.

5. The method according to claim 1, establishing the wavelet coefficients mapping function further comprises determining a range of magnitude values of the wavelet coefficients, where the wavelet coefficients with magnitude within said range are set to zero, the range is determined based on estimated noise variance in the captured fringe pattern.

6. A method according to claim 1, wherein the rate of change of the established wavelet coefficients mapping function is non-linearly dependent on the carrier frequency component.

7. A method according to claim 6, wherein the rate of change of the established wavelet coefficients mapping function determines a suppressing rate for the wavelet coefficients with a magnitude outside the predetermined range, wherein the rate of change of the established wavelet coefficients mapping function is independent of the predetermined range.

8. A method according to claim 1, wherein the transforming the obtained wavelet coefficients further comprising:
setting the magnitude of wavelet coefficients with magnitude within a predetermined range to zero; and
suppressing the magnitude of at least one wavelet coefficient with magnitude outside the predetermined range in accordance with the suppressing rate determined based on the carrier frequency component, the suppressing rate in the vicinity of the predetermined range being established by the wavelet coefficients mapping function to be independent of the size of the predetermined range.

9. A method according to claim 1, wherein the wavelet coefficients mapping function is further determined using strength to which the fringe pattern is modulated by an object being imaged using the energy source.

10. An image processing method for processing a fringe pattern captured by an X-Ray Talbot interferometer, the method comprising:
capturing a fringe pattern of an object being imaged by the X-Ray Talbot interferometer, the fringe pattern being modulated in accordance with a modulation strength introduced by the object;
determining a carrier frequency component associated with the captured fringe pattern, wherein the carrier frequency component is dependent on at least one grating used in the X-Ray Talbot interferometer;
obtaining wavelet coefficients for the captured fringe pattern by applying a wavelet transform to the captured fringe pattern;
establishing a wavelet coefficients mapping function that varies depending on the carrier frequency component of the captured fringe pattern and the modulation strength introduced by the object;
transforming the obtained wavelet coefficients using the established wavelet coefficients mapping function;
de-noising the captured fringe pattern by applying inverse wavelet transform to the transformed wavelet coefficients to form a denoised fringe pattern; and
demodulating the de-noised fringe pattern to determine object phase data associated with the optical path length of the object.

11. An image de-noising method for de-noising a fringe pattern captured by an X-Ray Talbot interferometer, the method comprising:
capturing a fringe pattern from the X-Ray Talbot interferometer, the captured fringe pattern having a carrier frequency component dependent on settings of the X-Ray Talbot interferometer;
obtaining wavelet coefficients for the captured fringe pattern by applying a wavelet transform to the captured fringe pattern;
suppressing the obtained wavelet coefficients in accordance with the carrier frequency component of the captured fringe pattern, wherein the suppressing rate increases with increasing the carrier frequency of the captured fringe pattern; and
de-noising the captured fringe pattern by applying inverse wavelet transform to the suppressed wavelet coefficients to form denoised fringe pattern.

12. A method according to claim 1, wherein the wavelets coefficient mapping function comprises a thresholding function expressed by:
$$ω = \{ \begin{matrix}\frac{T * y - sgn ( y ) F + sgn ( y ) \sqrt{{[ sgn ( y ) F + T * y ]}^{2} - 4 {T}^{2} F}}{2 T} & \vert y \vert \geq T > 0 \\ 0 , & otherwise\end{matrix} \qquad ( 3 )$$
where T is the dead zone size and F is a curvature parameter that changes the shape of the function.

13. A method according to claim 12, wherein the thresholding function is interpreted using the expression:
$$y = \{ \begin{matrix}ω + \frac{T * F}{ω * T + sgn ( ω ) * F} & \vert w \vert > 0 \\ \pm T , & otherwise\end{matrix} \qquad ( 4 )$$
where ‘*’ indicates multiplication, and that solving Equation (4) for ω will result in Equation (3), Equation (4) defines a mapping from noisy wavelet coefficients y to denoised wavelet coefficients ω, such that in Equations (3) and (4), sgn(x)=1 where x>0, and sgn(x)=−1 where x<0.

14. A method according to claim 10, wherein the wavelets coefficient mapping function comprises a thresholding function expressed by:
$$ω = \{ \begin{matrix}\frac{T * y - sgn ( y ) F + sgn ( y ) \sqrt{{[ sgn ( y ) F + T * y ]}^{2} - 4 {T}^{2} F}}{2 T} & \vert y \vert \geq T > 0 \\ 0 , & otherwise\end{matrix} \qquad ( 3 )$$
where T is the dead zone size and F is a curvature parameter that changes the shape of the function.

15. A method according to claim 14, wherein the thresholding function is interpreted using the expression:
$$y = \{ \begin{matrix}ω + \frac{T * F}{ω * T + sgn ( ω ) * F} & \vert w \vert > 0 \\ \pm T , & otherwise\end{matrix} \qquad ( 4 )$$
where ‘*’ indicates multiplication, and that solving Equation (4) for ω will result in Equation (3), Equation (4) defines a mapping from noisy wavelet coefficients y to denoised wavelet coefficients ω, such that in Equations (3) and (4), sgn(x)=1 where x>0, and sgn(x)=−1 where x<0.

16. A computer readable storage medium having a program recorded thereon, the program being executable by computer apparatus to process an image, the program comprising:
code for capturing a fringe pattern from an energy source, the captured fringe pattern having a carrier frequency component dependent on settings of the energy source;
code for obtaining wavelet coefficients for the captured fringe pattern by applying a wavelet transform to the captured fringe pattern;
code for establishing a wavelet coefficients mapping function having a rate of change that varies depending at least on the carrier frequency component of the captured fringe pattern;
code for transforming the obtained wavelet coefficients using the established wavelet coefficients mapping function; and
code for processing the captured fringe pattern by applying inverse wavelet transform to the transformed wavelet coefficients to form a denoised fringe pattern.

17. An X-ray Talbot imaging system comprising:
imaging apparatus for capturing a fringe pattern from an energy source, the captured fringe pattern having a carrier frequency component dependent on settings of the energy source;
a computing apparatus configured to:
obtain wavelet coefficients for the captured fringe pattern by applying a wavelet transform to the captured fringe pattern;
establish a wavelet coefficients mapping function having a rate of change that varies depending at least on the carrier frequency component of the captured fringe pattern;
transform the obtained wavelet coefficients using the established wavelet coefficients mapping function; and
process the captured fringe pattern by applying inverse wavelet transform to the transformed wavelet coefficients to form a denoised fringe pattern; and
a tangible memory configured to at least store the denoised fringe pattern.

18. A computer readable storage medium having a program recorded thereon, the program being executable by computer apparatus to process an image, the program comprising:
code for capturing a fringe pattern from an energy source, the captured fringe pattern having a carrier frequency component dependent on settings of the energy source;
code for obtaining wavelet coefficients for the captured fringe pattern by applying a wavelet transform to the captured fringe pattern;
code for establishing a wavelet coefficients mapping function that varies depending on the carrier frequency component of the captured fringe pattern;
code for transforming the obtained wavelet coefficients using the established wavelet coefficients mapping function; and
code for processing the captured fringe pattern by applying inverse wavelet transform to the transformed wavelet coefficients to form a denoised fringe pattern.

19. A computer readable storage medium having a program recorded thereon, the program being executable by computer apparatus to process an image, the program comprising:
code for capturing a fringe pattern from an energy source, the captured fringe pattern having a carrier frequency component dependent on settings of the energy source;
code for obtaining wavelet coefficients for the captured fringe pattern by applying a wavelet transform to the captured fringe pattern;
code for suppressing the obtained wavelet coefficients in accordance with the carrier frequency component of the captured fringe pattern, wherein the suppressing rate increases with increasing the carrier frequency of the captured fringe pattern; and
code for processing the captured fringe pattern by applying inverse wavelet transform to the suppressed wavelet coefficients to form denoised fringe pattern.
